(19) United States
(12) Patent Application Publication
(10) Pub. No.: US 2023/0038415 A1
(43) Pub. Date: Feb. 9, 2023

(54) DIAGNOSIS DEVICE

(71) Applicant: FANUC CORPORATION, Yamanashi (JP)

(72) Inventors: Kazuhiro SATOU, Yamanashi (JP); Kazunori IIJIMA, Yamanashi (JP)

(21) Appl. No.: 17/760,098

(22) PCT Filed: Feb. 5, 2021
(86) PCT No.: PCT/JP2021/004199

§ 371 Date: Aug. 4, 2022

(30) Foreign Application Priority Data
Feb. 7, 2020 (JP) 2020-020064

(51) Int. Cl. G05B 23/02; G05B 19/4063

(52) U.S. Cl. CPC G05B 23/0289; G05B 19/4063; G05B 2223/02; G05B 2219/32229

(57) ABSTRACT

A diagnosis device stores a model used for diagnosing the condition of an industrial machine in a storage unit, acquires data related to the condition of the industrial machine, and based on the acquired data, determines the condition of the industrial machine by using the model stored in the storage unit. Then, in response to detecting that a component of the industrial machine has been replaced based on the acquired data and the data related to the determined condition of the industrial machine, the diagnosis device adapts the model stored in the storage unit to the condition of the industrial machine whose component has been replaced.

### RELATED APPLICATIONS

The present application is a National Phase of International Application No. PCT/JP2021/004199 filed Feb. 5, 2021, which claims priority to Japanese Patent Application No. 2020-020064, filed Feb. 7, 2020.

### TECHNICAL FIELD

The present invention relates to a diagnosis device.

### BACKGROUND ART

As a method for diagnosing the condition of industrial machines such as a machine tool or a robot, a method of creating a model used for predetermined diagnosis for respective industrial machines and using the created model to perform diagnosis based on data acquired from the industrial machines is known (for example, Patent Literature 1 and the like). A diagnosis device that diagnoses the condition of industrial machines by such a method constructs a model used for diagnosing the condition based on data acquired when the industrial machines are normally operating and uses the constructed model to diagnose the condition of the industrial machines. Since models are constructed by using data acquired from respective industrial machines even when there is an individual difference between the industrial machines, it is possible to maintain the accuracy of condition diagnosis.

### CITATION LIST

### Patent Literature

Patent Literature 1: Japanese Patent Application Laid-Open No. 2017-033526

### SUMMARY OF INVENTION

### Technical Problem

When an industrial machine operates in a factory, once data out of the normal condition is acquired due to occurrence of wear, defect, or the like of a component, for example, the diagnosis device diagnoses that the condition of the industrial machine is abnormal. When the condition of the industrial machine is diagnosed as abnormal, the operator stops the operation of the industrial machine and performs maintenance work. In maintenance work, respective parts are adjusted, or components are replaced. After the maintenance work, the operator restarts the operation of the industrial machine.

The condition of the restarted industrial machine operating is diagnosed by the diagnosis device again. If diagnosis is continued by using the previously used model without any modification, however, the accuracy in condition diagnosis of the industrial machine may be reduced because there is an individual difference between components replaced by maintenance or the like. To maintain the accuracy of condition diagnosis in such a case, a diagnosis model adaptation process such as model relearning, additional learning, model parameter adjustment, model switching, or the like is required. In general, however, an industrial machine does not have its own function of explicitly detecting a timing that a component was replaced. Thus, when an operator has replaced a component in maintenance or the like, the operator is required to determine by himself/herself whether or not adaptation of the diagnosis model is necessary and to manually input an adaptation instruction of the diagnosis model to the diagnosis device. Such work is a burden on the operator, and in particular, providing an adaptation instruction of a diagnosis model to an industrial machine which requires frequent replacement of components is a huge burden.

Thus, there is a demand for a technology of causing a model adaptation process to be performed as needed even without an explicit instruction when maintenance work such as replacement of a component is performed.

### Solution to Problem

A diagnosis device according to the present invention determines a timing of a model adaptation process by using any of operational status information, setting information, and a value of a diagnosis result of a machine to be diagnosed, provides display to urge the user to decide to perform the model adaptation process or automatically performs the model adaptation process, and thereby solves the above problem.

Accordingly, one aspect of the present invention is a diagnosis device for diagnosing a condition of an industrial machine, and the diagnosis device includes: a model storage unit that stores a model used for diagnosing the condition of the industrial machine; a data acquisition unit that acquires data related to the condition of the industrial machine; a condition determination unit that, based on the data acquired by the data acquisition unit, determines the condition of the industrial machine by using the model stored in the model storage unit; a component replacement detection unit that, based on the data acquired by the data acquisition unit and the data related to the condition of the industrial machine determined by the condition determination unit, detects that a component of the industrial machine was replaced; and an model adaptation execution unit that, when it is detected that a component of the industrial machine was replaced, adapts the model stored in the model storage unit to diagnosis of the condition of the industrial machine whose component was replaced.

### Advantageous Effects of Invention

According to one aspect of the present invention, a timing to perform a model adaptation process can be notified or automatically determined, and the burden on the operator can be reduced.

### BRIEF DESCRIPTION OF DRAWINGS

FIG. 1 is a schematic hardware configuration diagram of a diagnosis device according to one embodiment.

FIG. 2 is a schematic function block diagram of a diagnosis device according to a first embodiment.

### DESCRIPTION OF EMBODIMENTS

Embodiments of the present invention will be described below with reference to the drawings.

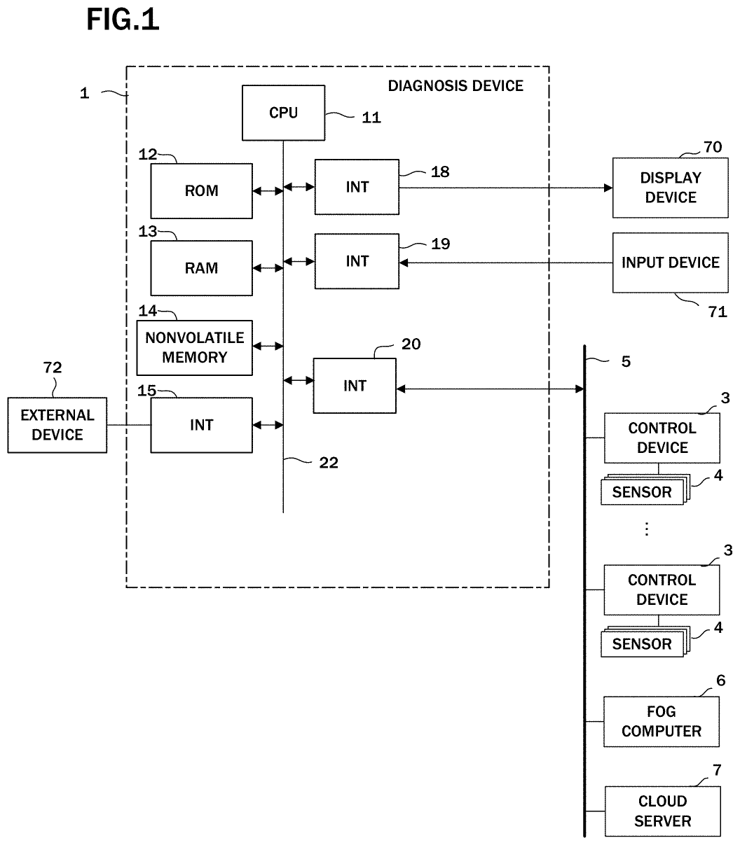

FIG. 1 is a schematic hardware configuration diagram illustrating a main part of a diagnosis device according to one embodiment of the present invention. A diagnosis device 1 of the present invention can be implemented as a control device that controls an industrial machine, for example, and can be implemented on a personal computer arranged together with a control device that controls an industrial machine or on a personal computer, a fog computer, or a cloud server connected to the control device via a wired/wireless network. In the present embodiment, the diagnosis device 1 is implemented on a personal computer connected via a network to a control device that controls an industrial machine.

A CPU 11 of the diagnosis device 1 according to the present embodiment is a processor that controls the overall diagnosis device 1. The CPU 11 reads a system program stored in a ROM 12 via a bus 22 and controls the entire diagnosis device 1 in accordance with the system program. A RAM 13 temporarily stores temporary calculation data or display data and various data or the like that are externally input.

A nonvolatile memory 14 is formed of a memory, a solid state drive (SSD), or the like backed up by a battery (not illustrated), for example, and the storage state is maintained even when the diagnosis device 1 is powered off. The nonvolatile memory 14 stores data or a control program loaded from an external device 72 via an interface 15, data or a control program input via an input device 71, various data acquired from other computers such as a control device 3 that controls an industrial machine provided with a sensor 4, a fog computer 6, or a cloud server 7, or the like. Such data may include, for example, data or the like acquired from the sensor 4 such as a load detector, an ammeter/voltmeter, a sound detector, or a photodetector provided for detecting the operation state of an industrial machine. Data or a control program stored in the nonvolatile memory 14 may be loaded into the RAM 13 when the control program is executed or when the data is used. Further, various system programs such as a known analysis program are written in advance in the ROM 12.

The interface 15 is an interface for connecting the CPU 11 of the diagnosis device 1 and the external device 72 such as a USB device to each other. For example, a control program, various parameters, or the like used for control of an industrial machine can be loaded from the external device 72 side. Further, a control program, various parameters, or the like modified in the diagnosis device 1 can be stored in an external storage device via the external device 72 or can be transmitted to the control device 3 or another computer via the network 5.

On a display device 70, each data loaded into a memory, data obtained as a result of execution of a control program, a system program, or the like, are output and displayed via an interface 18. Further, the input device 71 formed of a keyboard, a pointing device, or the like passes an instruction, data, or the like based on an operation made by a worker via an interface 19 to the CPU 11.

An interface 20 is an interface for connecting the CPU of the diagnosis device 1 and the wired or wireless network 5 to each other. The control device 3 that controls an industrial machine, the fog computer 6, the cloud server 7, and the like are connected to the network 5, which communicate data with the diagnosis device 1, respectively.

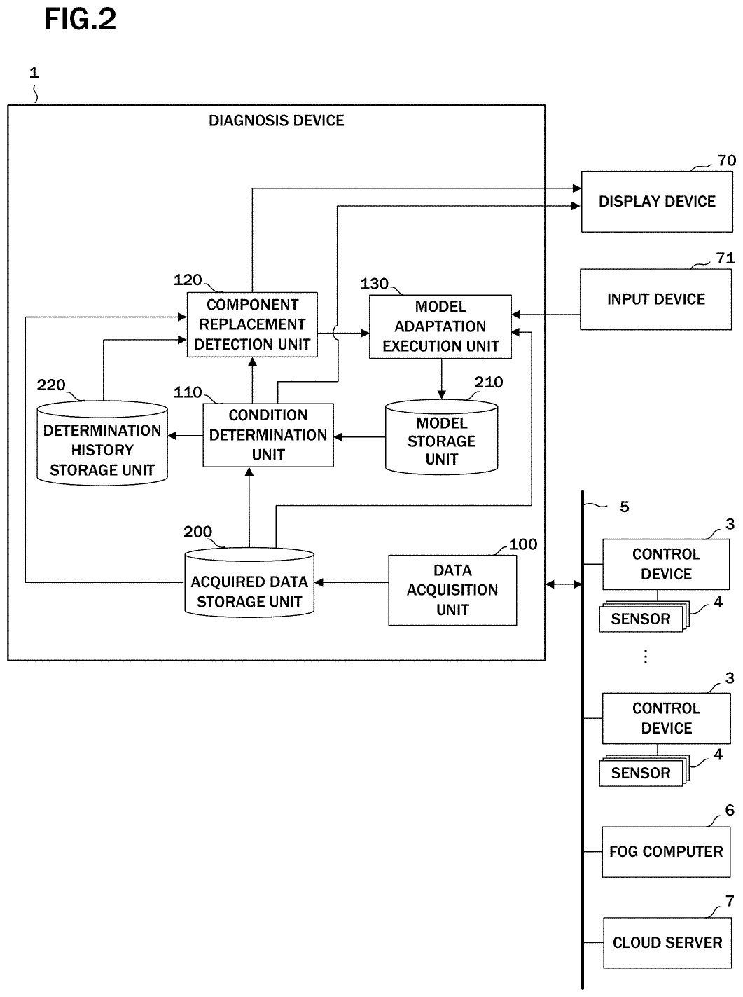

FIG. 2 illustrates functions of the diagnosis device 1 according to a first embodiment of the present invention as a schematic block diagram. Each function of the diagnosis device 1 according to the present embodiment is implemented when the CPU 11 of the diagnosis device 1 illustrated in FIG. 1 executes a system program and controls the operation of each unit of the diagnosis device 1.

The diagnosis device 1 of the present embodiment includes a data acquisition unit 100, a condition determination unit 110, a component replacement detection unit 120, and a model adaptation execution unit 130. Further, the RAM 13 or the nonvolatile memory 14 of the diagnosis device 1 is provided in advance with an acquired data storage unit 200 that stores data acquired from the control device 3 that controls an industrial machine, a model storage unit 210 in which a model used for diagnosis is stored in advance, and a determination history storage unit 220 that stores a history of condition determination results of an industrial machine from the condition determination unit 110.

The data acquisition unit 100 is implemented when the CPU 11 of the diagnosis device 1 illustrated in FIG. 1 executes a system program read from the ROM 12 and mainly the CPU 11 performs a calculation process using the RAM 13 and the nonvolatile memory 14 and a communication process using the interface 20. The data acquisition unit 100 acquires data indicating the operation state of the industrial machine from the control device 3 that controls the industrial machine. The data acquired by the data acquisition unit 100 may be machine setting information such as various offset values, time constants, or the like set for an industrial machine or a control device. The data acquired by the data acquisition unit 100 may be machine operational status information such as information indicating that an industrial machine is operating or stopped, a position, a speed, or an acceleration of a drive unit of an industrial machine, a current/voltage value of the drive unit of an industrial machine, a load of a drive unit, a temperature of each unit, a sound around an industrial machine, an image of a captured motion range of an industrial machine, or the like. The data acquired by the data acquisition unit 100 may be data that can be directly acquired from an industrial machine or may be data detected by the sensor 4 attached to an industrial machine or a part around the industrial machine. The data acquired by the data acquisition unit 100 may be data acquired at a predetermined time or may be time-series data acquired at a predetermined cycle. The data acquired by the data acquisition unit 100 is stored in the acquired data storage unit 200 in association with the time of detection, an identifier of an industrial machine, or the like.

The condition determination unit 110 is implemented when the CPU 11 of the diagnosis device 1 illustrated in FIG. 1 executes a system program read from the ROM 12 and mainly the CPU 11 performs a calculation process using the RAM 13 and the nonvolatile memory 14. The condition determination unit 110 performs a condition determination process on an industrial machine by using a model used for diagnosis stored in the model storage unit 210 based on data acquired by the data acquisition unit 100. The model storage unit 210 stores a model used for diagnosis constructed in advance based on data on an industrial machine. The model used for diagnosis may be a model constructed by so-called unsupervised learning and may be, for example, a cluster of a data set acquired when an industrial machine is normally operating. In such a case, the condition determination unit 110 can diagnose whether the condition of an industrial machine is within a normal range or the industrial machine is performing an abnormal operation based on how far (what distance) the vector value of machine operational status information acquired from the industrial machine is distant from the cluster center of a data set acquired during a normal operation or the like.

The model used for diagnosis may be a model constructed by so-called supervised learning and may be, for example, a neural network or a regression equation that diagnoses whether an industrial machine is in a normal condition or an abnormal condition. In such a case, the condition determination unit 110 can input machine operational status information acquired from the industrial machine to the model and can diagnose whether the condition of the industrial machine is within a normal range or the industrial machine is performing an abnormal operation based on an output value (score value). A determination result provided by the condition determination unit 110 is output to the display device 70. If the condition determination unit 110 determines that the operation is in an abnormal condition, the condition determination unit 110 may display the fact of the determination on the display device 70 and alert the operator with light, sound, or the like. Further, if necessary, an instruction to stop the operation of the industrial machine may be output to the industrial machine (the control device 3 that controls the industrial machine) which was determined to be in an abnormal condition. The determination result of the condition of an industrial machine provided by the condition determination unit 110 is further output to the component replacement detection unit 120 and stored as determination history information in the determination history storage unit 220. At this time, the condition determination unit 110 may additionally store, as the determination history information, a predetermined calculation value used in the determination of the condition of the industrial machine (in the above example, the distance from the cluster center, a score value, or the like used in diagnosis).

The component replacement detection unit 120 is implemented when the CPU 11 of the diagnosis device 1 illustrated in FIG. 1 executes a system program read from the ROM 12 and mainly the CPU 11 performs a calculation process using the RAM 13 and the nonvolatile memory 14. Based on machine setting information or machine operational status information acquired from the control device 3 that controls an industrial machine or determination history information on the condition of an industrial machine from the condition determination unit 110, the component replacement detection unit 120 detects whether or not a component of the industrial machine has been replaced. For example, when the tool offset value has been changed in a negative direction over a predefined predetermined threshold in accordance with machine setting information, the component replacement detection unit 120 may detect that the tool has been replaced. For example, when an operation was once stopped after an alarm was issued on an industrial machine and the operation was then restarted after a predefined predetermined time elapsed, the component replacement detection unit 120 may detect that some component has been replaced. For example, when a determination result for the condition of an industrial machine from the condition determination unit 110 has turned around in the normal direction over a predetermined threshold compared to determination history information stored in the determination history storage unit 220, the component replacement detection unit 120 may detect that some component has been replaced. In addition to the above, the component replacement detection unit 120 may detect replacement of a component in an industrial machine by using at least any of machine setting information, machine operational status information, and a determination result provided by the condition determination unit 110 in accordance with the characteristics of the industrial machine. For example, replacement of a component may be detected from at least any of machine setting information, machine operational status information, and determination history information or a predetermined time-series change in the combination thereof. In response to detecting replacement of a component of an industrial machine, the component replacement detection unit 120 may display the fact of the detection on the display device 70. Further, in response to detecting replacement of a component of an industrial machine, the component replacement detection unit 120 may output the fact of the detection to the model adaptation execution unit 130.

The model adaptation execution unit 130 is implemented when the CPU 11 of the diagnosis device 1 illustrated in FIG. 1 executes a system program read from the ROM 12 and mainly the CPU 11 performs a calculation process using the RAM 13 and the nonvolatile memory 14. When replacement of a component of an industrial machine is detected, the model adaptation execution unit 130 performs a process of adapting a model stored in the model storage unit 210 to diagnosis of the condition of the industrial machine whose component has been replaced. For example, the model adaptation execution unit 130 may perform a relearning process using data acquired from an industrial machine whose component has been replaced and thereby adapt the model used for diagnosis to the industrial machine whose component has been replaced. For example, the model adaptation execution unit 130 may perform an additional learning process using data acquired from an industrial machine whose component has been replaced and thereby adapt the model used for diagnosis to the industrial machine whose component has been replaced. For example, the model adaptation execution unit 130 may adjust a parameter (for example, the center position of a cluster or spread of a cluster, a coefficient in an equation when the model is represented by the equation, a weight coefficient when the model is represented by a neural network, or the like) of the model used for diagnosis so as to be adapted to data acquired from an industrial machine whose component has been replaced and thereby adapt the model used for diagnosis to the industrial machine whose component has been replaced. For example, the model adaptation execution unit 130 may switch the model used for diagnosis to another model used for diagnosis adapted to data acquired from an industrial machine whose component has been replaced and thereby adapt the model used for diagnosis to the industrial machine whose component has been replaced.

In the diagnosis device 1 according to the present embodiment having the above configuration, in response to detecting replacement of a component in an industrial machine, the diagnosis device 1 automatically performs a process of adapting a model used for diagnosing the condition of an industrial machine to data acquired from the industrial machine whose component has been replaced. Thus, the operator is required neither to determine whether or not to perform a model adaptation process nor to perform the model adaptation process by himself/herself, and the burden on the operator can be reduced.

As one modified example of the diagnosis device 1 according to the present embodiment, in response to detecting replacement of a component of an industrial machine, the component replacement detection unit 120 may provide display to the display device 70 to confirm whether or not to perform a model adaptation process. In response to detecting replacement of a component of an industrial machine, the component replacement detection unit 120 may provide display such as “YYYY/MM/DD, did you replace a component A at HH:MM? If so, please apply a model adaptation process. (Yes/No)”, for example, and when the operator selects “Yes” in response, the model adaptation execution unit 130 performs the model adaptation process. It is possible to prevent an unnecessary model adaptation process by leaving the final decision to the user, because detection of replacement of a component performed by the component replacement detection unit 120 may be inaccurate.

Although one embodiment of the present invention has been described above, the present invention is not limited to only the example of the embodiment described above and can be implemented in various forms with addition of a suitable change.

1. A diagnosis device for diagnosing a condition of an industrial machine, the diagnosis device comprising:
a model storage unit that stores a model used for diagnosing the condition of the industrial machine;
a data acquisition unit that acquires data related to the condition of the industrial machine;
a condition determination unit that, based on the data acquired by the data acquisition unit, determines the condition of the industrial machine by using the model stored in the model storage unit;
a component replacement detection unit that, based on the data acquired by the data acquisition unit and the data related to the condition of the industrial machine determined by the condition determination unit, detects that a component of the industrial machine was replaced; and
a model adaptation execution unit that, when it is detected that a component of the industrial machine was replaced, adapts the model stored in the model storage unit to diagnosis of the condition of the industrial machine whose component was replaced.

2. The diagnosis device according to claim 1,
wherein in response to detecting replacement of a component of the industrial machine, the component replacement detection unit confirms whether or not a model adaptation process is required, and
wherein when input indicating that the model adaptation process is required is provided, the model adaptation execution unit adapts the model stored in the model storage unit to diagnosis of the condition of the industrial machine whose component was replaced.

3. The diagnosis device according to claim 1,
wherein the data acquisition unit acquires machine setting information set for the industrial machine and machine operational status information related to operational status of the industrial machine, and
wherein based on a change in at least any of the machine setting information, the machine operational status information, and the data related to the condition of the industrial machine, the component replacement detection unit detects that a component of the industrial machine was replaced.

4. The diagnosis device according to claim 1, wherein the component replacement detection unit detects replacement of a component based on a time-series change in a tool offset value of the industrial machine.

5. The diagnosis device according to claim 1, wherein the component replacement detection unit detects replacement of a component based on a time-series change in alarm information on the industrial machine.

6. The diagnosis device according to claim 1, wherein by performing a relearning process on the model stored in the model storage unit by using data acquired by the data acquisition unit after the component replacement detection unit detects replacement of a component, the model adaptation execution unit adapts the model to the condition of the industrial machine whose component was replaced.

7. The diagnosis device according to claim 1, wherein by performing an additional learning process on the model stored in the model storage unit by using data acquired by the data acquisition unit after the component replacement detection unit detects replacement of a component, the model adaptation execution unit adapts the model to the condition of the industrial machine whose component was replaced.

8. The diagnosis device according to claim 1, wherein by correcting a parameter of the model stored in the model storage unit so as to be adapted to data acquired by the data acquisition unit after the component replacement detection unit detects replacement of a component, the model adaptation execution unit adapts the model to the condition of the industrial machine whose component was replaced.
